(19) United States
(12) Patent Application Publication
(10) Pub. No.: US 2011/0181591 A1
(43) Pub. Date: Jul. 28, 2011

(54) SYSTEM AND METHOD FOR COMPOSITING 3D IMAGES

(76) Inventors: Ana Belen Benitez, Los Angeles, CA (US); Dong-Qing Zhang, Burbank, CA (US); Jim Arthur Fancher, Los Angeles, CA (US)

(21) Appl. No.: 12/514,855

(22) PCT Filed: Nov. 20, 2006
(86) PCT No.: PCT/US2006/045029

§ 371 Date: Feb. 8, 2011

(51) Int. Cl. G06T 15/50; G06T 15/00

(52) U.S. Cl. 345/426; 345/419

(57) ABSTRACT

A system and method for compositing 3D images that combines parts of or at least a portion of two or more images having 3D properties to create a 3D image. The system and method of the present disclosure provides for acquiring at least two three-dimensional (3D) images, obtaining metadata (e.g., lighting, geometry, and object information) relating to the at least two 3D images, mapping the metadata of the at least two 3D images into a single 3D coordinate system, and compositing a portion of each of the at least two 3D images into a single 3D image. The single 3D image can be rendered into a desired format (e.g., stereo image pair). The system and method can associate the rendered output with relevant metadata (e.g., interocular distance for stereo image pairs).

### TECHNICAL FIELD OF THE INVENTION

The present disclosure generally relates to computer graphics processing and display systems, and more particularly, to a system and method for compositing three-dimensional (3D) images.

### BACKGROUND OF THE INVENTION

Stereoscopic imaging is the process of visually combining at least two images of a scene, taken from slightly different viewpoints, to produce the illusion of three-dimensional depth. This technique relies on the fact that human eyes are spaced some distance apart and do not, therefore, view exactly the same scene. By providing each eye with an image from a different perspective, the viewer's eyes are tricked into perceiving depth. Typically, where two distinct perspectives are provided, the component images are referred to as the “left” and “right” images, also know as a reference image and complementary image, respectively. However, those skilled in the art will recognize that more than two viewpoints may be combined to form a stereoscopic image.

Stereoscopic images may be produced by a computer using a variety of techniques. For example, the “anaglyph” method uses color to encode the left and right components of a stereoscopic image. Thereafter, a viewer wears a special pair of glasses that filters light such that each eye perceives only one of the views.

Similarly, page-flipped stereoscopic imaging is a technique for rapidly switching a display between the right and left views of an image. Again, the viewer wears a special pair of eyeglasses that contains high-speed electronic shutters, typically made with liquid crystal material, which open and close in sync with the images on the display. As in the case of anaglyphs, each eye perceives only one of the component images.

Other stereoscopic imaging techniques have been recently developed that do not require special eyeglasses or headgear. For example, lenticular imaging partitions two or more disparate image views into thin slices and interleaves the slices to form a single image. The interleaved image is then positioned behind a lenticular lens that reconstructs the disparate views such that each eye perceives a different view. Some lenticular displays are implemented by a lenticular lens positioned over a conventional LCD display, as commonly found on computer laptops.

An application that is related to the above-described techniques is VFX compositing for 3D images (e.g., stereoscopic images). Currently, existing compositing software such as Apple Shake™ and Autodesk Combustion™ are used in this process. However, these software systems handle the left-eye and right-eye images in a stereo image pair independently during compositing and rendering.

Therefore, the current process of VFX compositing for stereoscopic images is a trial-and-error operation lacking a systematic way for the operator to determine the appropriate camera position, lighting model, etc., for correctly rendering the left and right images. Such trial-and-error process could result in inaccurate object depth estimations and inefficient compositing workflows.

In addition, these software systems do not allow the operator to modify specific settings for the rendered stereo images such as the interocular distance. Inappropriate interocular distances may result in constantly changing convergence planes in a 3D motion picture that causes visual fatigue to the audience.

### SUMMARY

A system and method for compositing 3D images that combines parts of or at least a portion of two or more images having 3D properties to create a 3D image. The system and method of the present disclosure ingests two or more input images. The input to the system could be a stereo image pair with left and right eye views, a single eye image with depth map corresponding to the view, a 3D model for a computer graphic (CG) object, a 2D foreground and/or background plate, and combinations of these, among others. The system and method then acquires or extracts relevant metadata such as lighting, geometry, and object information for the ingested images. In response to input from an operator, the system and method selects or modifies image data such as lighting, geometry and objects for each ingested image. The system and method for compositing 3D images then maps the selected or modified image data to the same coordinate system and combines image data into a single 3D image based on directions and settings provided by the operator. At this point, the operator can decide whether to modify the settings or to render the combined 3D image into the desired format (e.g., a stereo image pair). The system and method can associate the rendered output with relevant metadata (e.g., interocular distance for stereo image pairs).

According to one aspect of the present disclosure, a method for compositing three-dimensional (3D) images includes acquiring at least two three-dimensional (3D) images, obtaining metadata relating to the at least two 3D images, mapping the metadata of the at least two 3D images into a single 3D coordinate system, and compositing a portion of each of the at least two 3D images into a single 3D image. The metadata includes but is not limited to lighting information, geometry information, object information and combinations thereof.

In another aspect, the method further includes rendering the single 3D image in a predetermined format.

In a further aspect, the method further includes associating output metadata with the rendered 3D image.

According to another aspect of the present disclosure, a system for compositing three-dimensional (3D) images is provided. The system includes means for acquiring at least two three-dimensional (3D) images, an extractor configured for obtaining metadata relating to the at least two 3D images, a coordinate mapper configured for mapping the metadata of the at least two 3D images into a single 3D coordinate system, and a compositor configured for compositing a portion of each of the at least two 3D images into a single 3D image.

In one aspect, the system includes a color corrector configured for modifying at least one attribute of the metadata.

In another aspect, the extractor further includes a light extractor configured for determining a light environment of the at least two 3D images.

In a yet a further aspect, the extractor further includes a geometry extractor configured for determining geometry of the scene or an object in the at least two 3D images.

According to another aspect, a program storage device readable by a machine, tangibly embodying a program of instructions executable by the machine to perform method steps for compositing three-dimensional (3D) images is provided, the method including acquiring at least two three-dimensional (3D) images, obtaining metadata relating to the at least two 3D images, mapping the metadata of the at least two 3D images into a single 3D coordinate system, compositing a portion of each of the at least two 3D images into a single 3D image, and rendering the single 3D image in a predetermined format.

### BRIEF DESCRIPTION OF THE DRAWINGS

These, and other aspects, features and advantages of the present disclosure will be described or become apparent from the following detailed description of the preferred embodiments, which is to be read in connection with the accompanying drawings.

In the drawings, wherein like reference numerals denote similar elements throughout the views:

FIG. 1 is an exemplary illustration of a system for compositing at least two three-dimensional (3D) images into a single 3D image according to an aspect of the present disclosure;

FIG. 2 is a flow diagram of an exemplary method for compositing at least two three-dimensional (3D) images into a single 3D image according to an aspect of the present disclosure; and

FIG. 3 illustrates two three-dimensional images being mapped to a single 3D coordinate system according to an aspect of the present disclosure.

It should be understood that the drawing(s) is for purposes of illustrating the concepts of the disclosure and is not necessarily the only possible configuration for illustrating the disclosure.

### DETAILED DESCRIPTION OF PREFERRED EMBODIMENTS

It should be understood that the elements shown in the FIGS. may be implemented in various forms of hardware, software or combinations thereof. Preferably, these elements are implemented in a combination of hardware and software on one or more appropriately programmed general-purpose devices, which may include a processor, memory and input/output interfaces.

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

Compositing is a standard process widely used in motion picture production to combine multiple images from different sources into one image to achieve certain visual effects. The conventional compositing workflow was developed for processing 2D motion pictures, and it is not optimized for processing 3D motion pictures (e.g. 3D stereoscopic motion picture).

The present disclosure addresses the problem of combining parts of or at least a portion of two or more images with 3D properties into a new single 3D image. The present disclosure provides a system and method that can combine at least a portion of each of the two or more images with three-dimensional (3D) properties into a new 3D image. A wide range of 3D images is supported including, but not limited to, stereo image pairs, 2D images with depth maps, 3D models for CG objects, foreground and/or background plates and the like. In addition, the system and method can ingest, extract, and output relevant metadata about the compositing process. The system and method allows for the inclusion or exclusion of objects in a particular plane (clipping) and for blending objects based on instructions specified by the operator.

The input to the system could be a stereo image pair with left and right eye views, a single eye image with depth map corresponding to the view, a 3D model for a computer graphic object, a 2D foreground and/or background plate, and combinations of these, among others. The output from the system could be a stereo image pair of left and right eye views or any other type of 3D images that renders and composites the combination of the input images as specified by the operator. Both input and output images can be associated with relevant metadata such as the assumed interocular distance and lighting model for stereo image pairs, among others. In addition, output metadata can be used to facilitate additional processing by other applications (e.g., change interocular distance).

The system and method may employ conventional VFX tools such as a color corrector and a light model generator. This is needed when the input images do not include lighting models or detailed-enough geometry information. The system and method also provides for merging and modifying the lighting models as well as the 3D geometry of the input images. These models can be merged or modified based on instructions selected or specified by the operator.

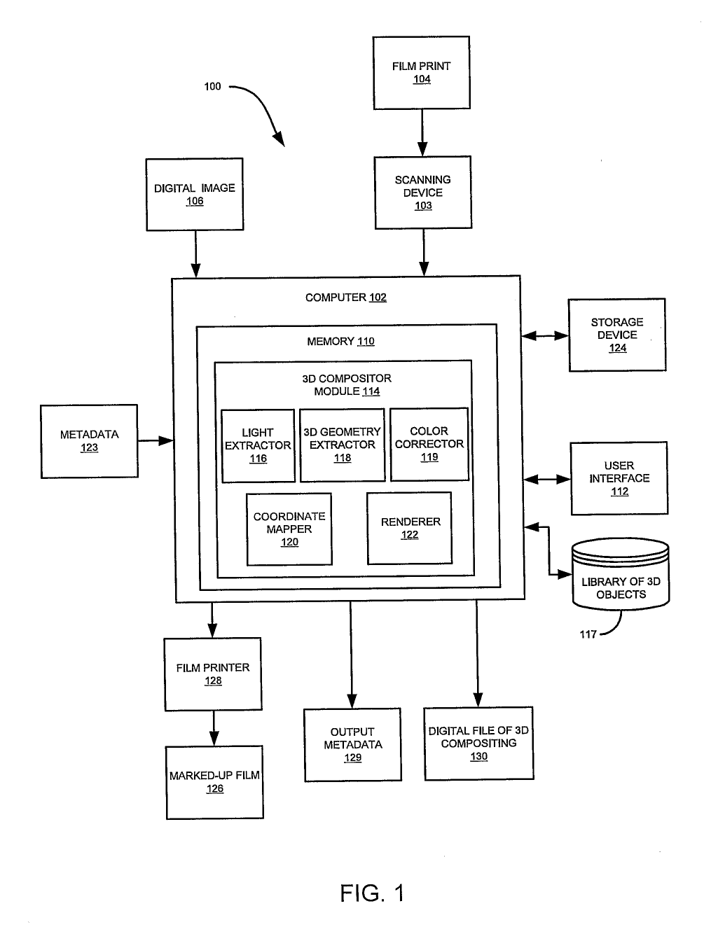

Referring now to the Figures, exemplary system components according to an embodiment of the present disclosure are shown in FIG. 1. A scanning device 103 may be provided for scanning film prints 104, e.g., camera-original film negatives, into a digital format, e.g. Cineon-format or SMPTE DPX files. The scanning device 103 may comprise, e.g., a telecine or any device that will generate a video output from film such as, e.g., an Arri LocPro™ with video output. Alternatively, files from the post production process or digital cinema 106 (e.g., files already in computer-readable form) can be used directly. Potential sources of computer-readable files include, but are not limited to, AVID™ editors, DPX files, D5 tapes and the like.

Scanned film prints are input to a post-processing device 102, e.g., a computer. The computer is implemented on any of the various known computer platforms having hardware such as one or more central processing units (CPU), memory 110 such as random access memory (RAM) and/or read only memory (ROM) and input/output (I/O) user interface(s) 112 such as a keyboard, cursor control device (e.g., a mouse or joystick) and display device. The computer platform also includes an operating system and micro instruction code. The various processes and functions described herein may either be part of the micro instruction code or part of a software application program (or a combination thereof) which is executed via the operating system. In addition, various other peripheral devices may be connected to the computer platform by various interfaces and bus structures, such a parallel port, serial port or universal serial bus (USB). Other peripheral devices may include additional storage devices 124 and a printer 128. The printer 128 may be employed for printed a revised version of the film 126, e.g., a stereoscopic version of the film, wherein a scene or a plurality of scenes may have been altered or replaced using 3D modeled objects as a result of the techniques described below.

Alternatively, files/film prints already in computer-readable form 106 (e.g., digital cinema, which for example, may be stored on external hard drive 124) may be directly input into the computer 102. Note that the term “film” used herein may refer to either film prints or digital cinema.

A software program includes a three-dimensional (3D) compositor module 114 stored in the memory 110 for combining at least a portion of at least two 3D images into a single 3D image. The 3D compositor module 114 includes light extractor 116 for predicting the light environment of objects that are to be placed in a scene. The light extractor 116 may interact with a plurality of light models to determine the light environment. A 3D geometry detector 118 is provided for extracting geometry information and identifying objects in the 3D images. The 3D geometry detector 118 identifies objects either manually by outlining image regions containing objects by image editing software or by isolating image regions containing objects with automatic detection algorithms. A color corrector 119 is provided to alter the color, brightness, contrast, color temperature, etc., of an image or part of the image. The color correction functionality implemented by the color corrector 119 includes, but is not limited to, region selection, color grading, defocus, key channel and matting, Gamma control, rightness and contrast and the like.

The 3D compositor module 114 also includes a coordinate mapper 120 for mapping objects from a library of 3D objects 117 or from the input images to a single coordinate system. A renderer 122 is provided for rendering objects in a scene with lighting information generated by the light extractor 116, among others. Renderers are known in the art and include, but are not limited to, LightWave 3D, Entropy and Blender.

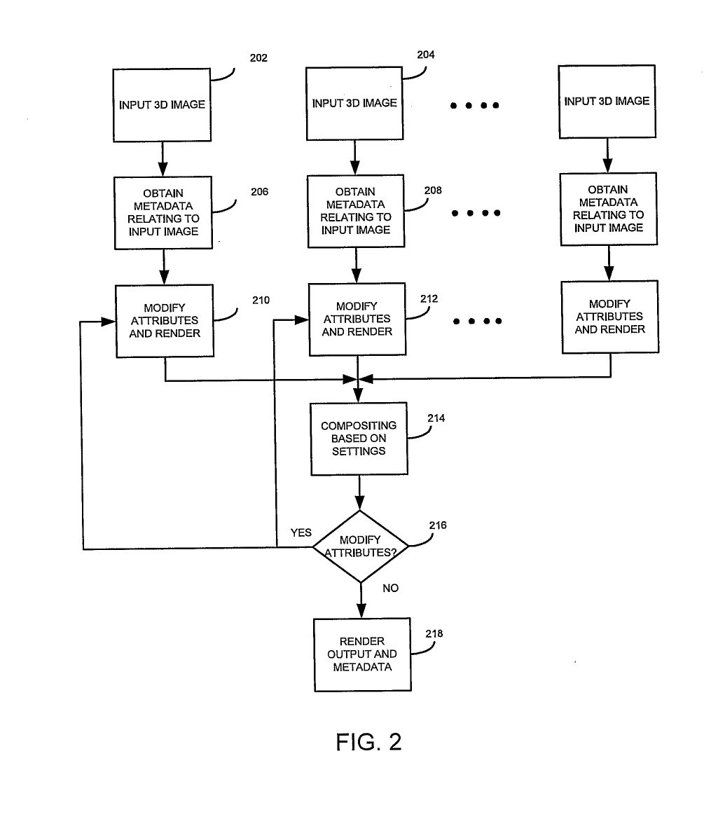

FIG. 2 is a flow diagram of an exemplary method for compositing parts of or a portion of at least two 3D images into a single 3D image according to an aspect of the present disclosure. Initially, the post-processing device 102, at step 202, acquires at least two three-dimensional (3D) images, e.g., a stereo image pair with left and right eye views, a single eye image with depth map corresponding to the view, a 3D model for a computer graphic (CG) object, a 2D foreground and/or background plate, and combinations of these, among others. The post-processing device 102 may acquire the at least two 3D images by obtaining the digital master image file in a computer-readable format. The digital video file may be acquired by capturing a temporal sequence of moving images with a digital camera. Alternatively, the video sequence may be captured by a conventional film-type camera. In this scenario, the film is scanned via scanning device 103.

It is to be appreciated that whether the film is scanned or already in digital format, the digital file of the film will include indications or information on locations of the frames, e.g., a frame number, time from start of the film, etc. Each frame of the digital image file will include one image, e.g., I₁, I₂, . . . Iₙ.

Once the digital file is acquired, two or more input images can be ingested. Relevant metadata such as lighting, geometry, and object information can also be inputted to or extracted by the system, as needed. The next step is for the operator to select or modify attributes of the metadata such as the lighting, geometry, objects, etc for each input image, as desired. The inputs are then mapped to the same coordinate system and combined into a single 3D image based on directions and settings from the operator. At that point, the operator can decide whether to modify the settings or to render and composite the combined 3D image into the desired format (e.g., stereo image pair). The rendered output can be associated with relevant metadata (e.g., interocular distance for stereo image pairs).

Referring to FIG. 2, at least two 3D images are input in steps 202 and 204. A wide range of 3D images is supported as the input to the 3D image compositor. For example, stereo image pairs with left and right eye views, single eye images with depth map corresponding to the view, 3D models for a computer graphic object, 2D foreground or background plates, and combinations of these, could be the input to the system.

Next, at steps 206 and 208, the system will acquire lighting, geometry, object and other information for the input images, All input images can be ingested with relevant metadata 123 such as the camera distance and lighting model for stereo image pairs, among others. Ingest means to accept as input images and process as necessary. For example, to input two stereo images and to extract depth maps from them. If the necessary metadata for compositing is not available, the system can extract the metadata in a semi-automatic or automatic way from the input images using the modules described above in relation to FIG. 1. For example, the light extractor 116 will determine a lighting environment of a scene and predict the light information, e.g., radiance, at a particular point in the scene. Additionally, the geometry extractor 118 will extract the geometry of the scene or portions of the input images from the images along with other relevant data such as camera parameters, depth maps, etc. Furthermore, the metadata may be manually input by an operator, for example, a lighting model generated in relation to a particular image may be associated to the image. The metadata may be obtained or received from external sources, for example, 3D geometry can be acquired by geometry capturing devices such as, e.g., laser scanners or other devices, and input to the geometry extractor 118. Similarly, light information can be captured by lighting capture devices such as, e.g., mirror balls, light sensors, cameras, etc., and input to the light extractor 116, among others.

The system can use conventional VFX tools to extract or generate the relevant metadata 123 needed for the compositing process. Such tools include, but are not limited to, color correcting algorithms, geometry detection algorithms, light modeling algorithms, and the like. These tools are needed when the 3D input images do not include lighting models or detailed-enough geometry information. Other relevant metadata that the system can use is camera distance for stereo image pairs, among others.

Once information about the geometry (depth map, etc) is extracted for the entire image or a portion of the picture that corresponds to some object the user is interested in, the system can also segment the objects appearing in the input images. For example, in a stereo image pair of person A and person B shaking hands, the system could segment the objects corresponding to person A, person B, and the background. Object segmentation algorithms are known in the art. The 3D geometry for the scene or object of interest in the image may be determined or refined by various methods such as model fitting, where predefined 3D models having known geometry are matched and registered to the region in the image corresponding to the object. In another exemplary method, the geometry of a segmented object may be derived or refined by matching the image region to a predefined particle system, where the particle system was generated to have a predetermined geometry.

In steps 210, 212, the system may enable an operator to modify attributes of the metadata, e.g., lighting, geometry, object and other information, for the at least two input images. If the 3D properties of the images are inaccurate or unavailable, they may need to be created or modified to obtain an accurate 3D compositing. For example, the depth map of background plates is often unavailable, due to the low depth resolution of 3D acquisition devices. In this case, the operators may need to assign 3D depth to some objects in the background plate as needed for the composition. The operator can also modify the lighting, geometry, objects, etc for each input image, as desired. The system provides for merging and modifying the lighting models as well as the 3D geometry of the input images or objects in the images. These models can be merged or modified based on instructions selected or specified by the operator (e.g., add a new lighting source in a desired location). Furthermore, the operator may employ the color corrector 119 to modify a “look” of an object or part of the acquired image by modifying light color, surface color and reflectance properties, light position and surface geometry. The images or portions of images will be rendered before or after the modifications to determine if modification or more modifications are necessary.

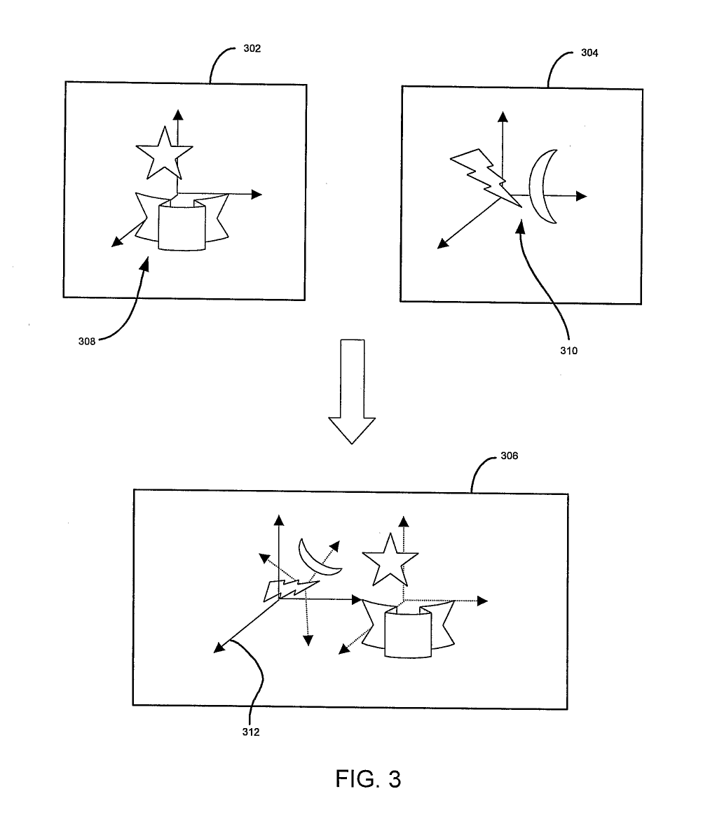

Next, in step 214, the compositing is performed based on the settings provided by the operator via the 3D compositing module 114. During this step, visual elements (e.g. objects) in the different input images are positioned in the same 3D coordinate system manually by the operator or automatically based on depth information, as illustrated in FIG. 3. Referring to FIG. 3, each input image 302, 304 includes objects, 308 and 310 respectively, in a coordinate system related to the input image. The objects 308, 310 from each input image 302, 304 will be mapped into a global coordinate system 312 of the new 3D image 306. The operator can modify and change the position or relation between the objects or portions of the input images. The system also allows the operator to include or exclude objects in a particular plane (clipping) and to blend the objects based on specific rules. Finally, the selected objects and input images are merged and combined based on instructions selected or specified by the operator e.g., specify the translation, rotation and scale transforms for the coordinate system of each image input with respect to global coordinate system. For example, objects 310 from input image 304 are rotated in relation to the global coordinate system 312 of the 3D image 306 and are scaled from their original size.

After the compositing step, the attributes of the metadata may need to be modified further (step 216). If the attributes need to be modified, the method will revert to steps 210, 212, otherwise, the composite 3D images may be rendered.

The composite 3D images are finally rendered, in step 218, via renderer 122 in the desired format, e.g., stereo image pairs of left and right eye views or any other type of 3D images. The output images can be associated with relevant metadata 129 such as the assumed interocular distance and lighting model for stereo image pairs, occlusion information for 3D images and associated depth map, among others. The metadata could be automatically generated, e.g., the interocular distance, or entered manually, e.g., light source positions and intensities.

The rendered image may then be stored in digital file 130. The digital file 130 may be stored in storage device 124 for later retrieval, e.g., to print a stereoscopic version of the original film.

Although the embodiment which incorporates the teachings of the present disclosure has been shown and described in detail herein, those skilled in the art can readily devise many other varied embodiments that still incorporate these teachings. Having described preferred embodiments for a system and method compositing 3D images (which are intended to be illustrative and not limiting), it is noted that modifications and variations can be made by persons skilled in the art in light of the above teachings. It is therefore to be understood that changes may be made in the particular embodiments of the disclosure disclosed which are within the scope and spirit of the disclosure as outlined by the appended claims.

1. A method for compositing three-dimensional images comprising:
acquiring at least two three-dimensional images;
obtaining metadata relating to the at least two three-dimensional images;
mapping the metadata of the at least two three-dimensional images into a single three-dimensional coordinate system; and
compositing a portion of each of the at least two three-dimensional images into a single three-dimensional image.

2. The method as in claim 1, wherein the metadata is at least one of lighting information, geometry information and object information.

3. The method as in claim 1, further comprising rendering the single three-dimensional image in a predetermined format.

4. The method as in claim 3, further comprising associating output metadata with the rendered three-dimensional image.

5. The method as in claim 4, wherein the predetermined format is a stereo image pair with left and right eye views, wherein the output metadata is an interocular distance between the left and right eye views of the stereo image pair.

6. The method as in claim 1, wherein each of the at least two acquired three-dimensional images is one of a stereo image pair with left and right eye views, a single eye view image with a depth map corresponding to the view, a three-dimensional model for a computer graphic object, and a two-dimensional foreground or background plate.

7. The method as in claim 3, further comprising modifying at least one attribute of the metadata of the at least two three-dimensional images (210, 212).

8. The method as in claim 1, wherein the step of obtaining metadata includes extracting the metadata from the at least two three-dimensional images.

9. The method as in claim 1, wherein the obtaining metadata includes receiving the metadata from at least one external source.

10. A system for compositing three-dimensional images comprising:
means for acquiring at least two three-dimensional images;
an extractor configured for obtaining metadata relating to the at least two three-dimensional images;
a coordinate mapper configured for mapping the metadata of the at least two three-dimensional images into a single three-dimensional coordinate system; and
a compositor configured for compositing a portion of each of the at least two three-dimensional images into a single three-dimensional image.

11. The system as in claim 10, further comprising a renderer configured for rendering the single three-dimensional image in a predetermined format.

12. The system as in claim 11, wherein the compositor is further configured for associating output metadata with the rendered three-dimensional image.

13. The system as in claim 10, wherein the metadata is at least one of lighting information, geometry information, and object information.

14. The system as in claim 10, further comprising a color corrector configured for modifying at least one attribute of the metadata of the images.

15. The system as in claim 10, wherein the extractor further comprises a light extractor configured for determining a light environment of the at least two three-dimensional images.

16. The system as in claim 10, wherein the extractor further comprises a geometry extractor configured for determining geometry of an object in the at least two three-dimensional images.

17. The system as in claim 10, wherein the extractor is further configured to receive the metadata from at least one external source.

18. A program storage device readable by a machine, tangibly embodying a program of instructions executable by the machine to perform method steps for compositing three-dimensional images, the method comprising:
acquiring at least two three-dimensional images;
obtaining metadata relating to the at least two three-dimensional images;
mapping the metadata of the at least two three-dimensional images into a single three-dimensional coordinate system;
compositing a portion of each of the at least two three-dimensional images into a single three-dimensional image; and
rendering the single three-dimensional image in a predetermined format.

19. The program storage device as in claim 18, wherein the metadata is at least one of lighting information, geometry information, and object information.

20. The program storage device as in claim 18, wherein the method further comprises associating output metadata with the rendered three-dimensional image.
